(19) United States
(12) Patent Application Publication
(10) Pub. No.: US 2026/0050347 A1
(43) Pub. Date: Feb. 19, 2026

(54) METHOD FOR PROVIDING INTERACTION WITH PROJECTED SCREEN AND ELECTRONIC DEVICE SUPPORTING THE SAME

(71) Applicant: SAMSUNG ELECTRONICS CO., LTD, Suwon-si (KR)

(72) Inventors: Ivan BONDARETS, Kyiv (UA); Veronika PROKHORCHUK, Kyiv (UA); Ihor ZARICHNYI, Kyiv (UA); Andrii KOZYR, Kyiv (UA); Oleksandr TRUNOV, Kyiv (UA)

(73) Assignee: SAMSUNG ELECTRONICS CO., LTD., Suwon-si (KR)

(21) Appl. No.: 19/304,039

(22) Filed: Aug. 19, 2025

Related U.S. Application Data
(63) Continuation of application No. PCT/KR2025/012495, filed on Aug. 18, 2025.

(30) Foreign Application Priority Data
Aug. 19, 2024 (KR) 10-2024-0110799

(51) Int. Cl. G06F 3/042; G06F 3/041

(52) U.S. Cl. CPC G06F 3/0425; G06F 3/0416; G06F 2203/04105

(57) ABSTRACT

An electronic device according to an embodiment may comprise a projector configured to project a screen, a light emitter, a camera, and at least one processor. The at least one processor may be configured to obtain an image of an area formed by light emitted by the light emitter through the camera while the screen is projected by the projector. The at least one processor may be configured to obtain probabilities that a touch on the area corresponds to a touch by a user's finger using a plurality of methods based on the obtained image, wherein the probabilities are obtained based on performing the plurality of methods, respectively. The at least one processor may be configured to determine whether the touch on the area is the touch by the user's finger based on the obtained probabilities.

### CROSS-REFERENCE TO RELATED APPLICATIONS

This application is a bypass continuation application of International Application No. PCT/KR2025/012495, filed on Aug. 18, 2025, which is based on and claims the benefit of Korean Patent Application No. 10-2024-0110799, filed on Aug. 19, 2024, in the Korean Intellectual Property Office, the disclosures of each of which are incorporated by reference herein in their entireties.

### BACKGROUND

### 1. Field

The disclosure relates to a method for providing interaction with a projected screen and an electronic device supporting the same.

### 2. Description of Background Art

A projector device (also referred to as a “projection device”) may provide various content by projecting a screen. For example, the projection device may project a screen related to content (and information) associated with movies, conferences, or education onto a flat surface such as a wall or table.

The projection device may provide interaction with the user. For example, the projection device may obtain a user input (e.g., touch input) for a screen projected through the projection device. The projection device may provide various functions based on a user input.

The above-described information may be provided as related art for the purpose of helping understanding of the present disclosure. No claim or determination is made as to whether any of the foregoing is applicable as prior art in relation to the disclosure.

### SUMMARY

The projection device may obtain a user input for a screen projected from the projection device based on an image obtained through a camera. For example, an infrared camera of the projection device may obtain an image by obtaining infrared rays that are emitted from an infrared emitter and then reflected while a screen is being projected from the projection device. The projection device may detect the user's touch on the projected screen based on the obtained image.

However, the projection device may have difficulty distinguishing whether the user's touch on the projected screen is an intended touch by the user or an unintended touch.

The projection device may need to distinguish whether the user's touch on the projected screen is a touch by the user's finger (e.g., a fingertip) according to the user's intention, or a touch by an object other than the user's finger contrary to the user's intention.

The disclosure relates to a method for providing interaction with a projected screen, which may distinguish whether the user's touch on a screen projected from an electronic device is an intended touch by the user or an unintended touch by the user using a plurality of methods, and an electronic device supporting the same.

Objects of the disclosure are not limited to the foregoing, and other unmentioned objects would be apparent to one of ordinary skill in the art from the following description.

An electronic device according to an embodiment may comprise a projector configured to project a screen, a light emitter, a camera, and at least one processor. The at least one processor may be configured to obtain an image of an area formed by light emitted by the light emitter through the camera while the screen is projected by the projector. The at least one processor may be configured to obtain probabilities that a touch on the area corresponds to a touch by a user's finger using a plurality of methods based on the obtained image. The probabilities may be obtained based on performing the plurality of methods, respectively. The at least one processor may be configured to determine whether the touch on the area is the touch by the user's finger based on the obtained probabilities.

A method for providing interaction with a screen projected from an electronic device according to an embodiment may comprise obtaining an image of an area formed by light emitted by a light emitter of the electronic device through a camera of the electronic device while the screen is projected by a projector of the electronic device. The method may comprise obtaining probabilities that a touch on the area corresponds to a touch by a user's finger using a plurality of methods based on the obtained image. The probabilities may be obtained based on performing the plurality of methods, respectively. The method may comprise determining whether the touch on the area is the touch by the user's finger based on the obtained probabilities.

### BRIEF DESCRIPTION OF DRAWINGS

FIG. 1 is a block diagram illustrating an electronic device in a network environment according to an embodiment;

FIG. 2 is a block diagram illustrating an electronic device according to an embodiment;

FIG. 3 is a view illustrating an electronic device according to an embodiment;

FIG. 4 is a view illustrating an electronic device according to an embodiment;

FIG. 5 is a view illustrating an electronic device according to an embodiment;

FIG. 6 is a flowchart illustrating a method for providing interaction with a projected screen according to an embodiment;

FIG. 7 is a flowchart illustrating a method for providing interaction with a projected screen according to an embodiment;

FIG. 8 is a view illustrating a method for obtaining a probability that a touch on an IR plane corresponds to an intended touch using a visual-based method according to an embodiment;

FIG. 9 is a view illustrating a method for obtaining a probability that a touch on an IR plane corresponds to an intended touch using a projection-based method according to an embodiment;

FIG. 10 is a view illustrating a method for obtaining a probability that a touch on an IR plane corresponds to an intended touch using a projection-based method according to an embodiment;

FIG. 11 is a view illustrating a method for obtaining a probability that a touch on an IR plane corresponds to an intended touch using a position tracking-based method according to an embodiment;

FIG. 12 is a view illustrating a method for obtaining a probability that a touch on an IR plane corresponds to an intended touch using a position tracking-based method according to an embodiment;

FIG. 13 is a view illustrating a method for obtaining a probability that a touch on an IR plane corresponds to an intended touch using a cluster-based method according to an embodiment;

FIG. 14 is a view illustrating a method for obtaining a probability that a touch on an IR plane corresponds to an intended touch using a cluster-based method according to an embodiment;

FIG. 15 is a view illustrating a method for obtaining a probability that a touch on an IR plane corresponds to an intended touch using a screen interaction-based method according to an embodiment;

FIG. 16 is a view illustrating a method for obtaining a probability that a touch on an IR plane corresponds to an intended touch using a screen interaction-based method according to an embodiment;

FIG. 17 is a view illustrating a method for obtaining a probability that a touch on an IR plane corresponds to an intended touch using a screen interaction-based method according to an embodiment;

FIG. 18 is a view illustrating a method for obtaining a probability that a touch on an IR plane corresponds to an intended touch using a screen interaction-based method according to an embodiment; and

FIG. 19 is a flowchart illustrating a method for obtaining a probability that a touch on an IR plane corresponds to an intended touch using the user style-based method according to an embodiment.

### DETAILED DESCRIPTION

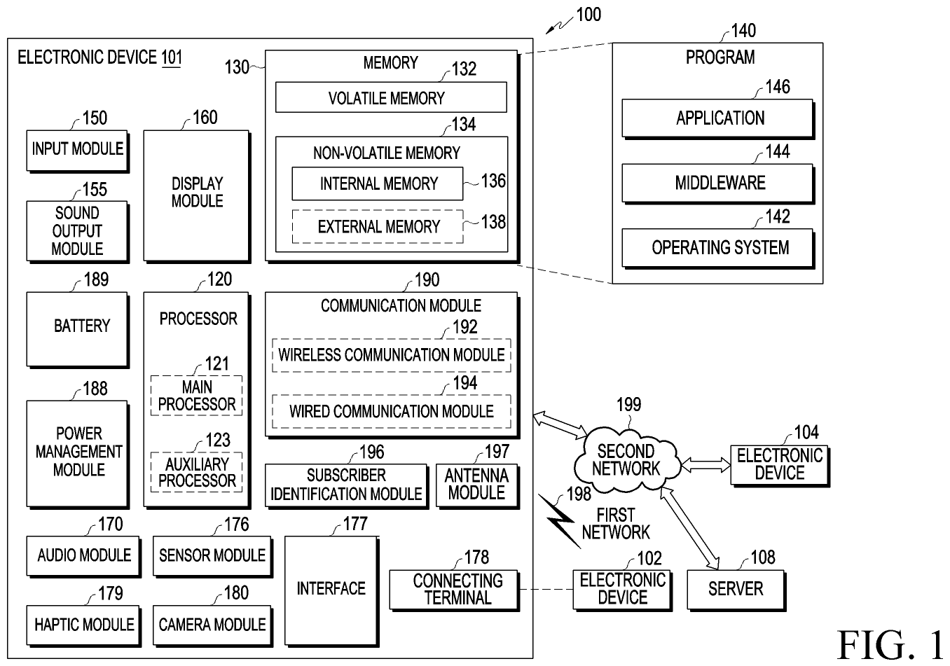

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

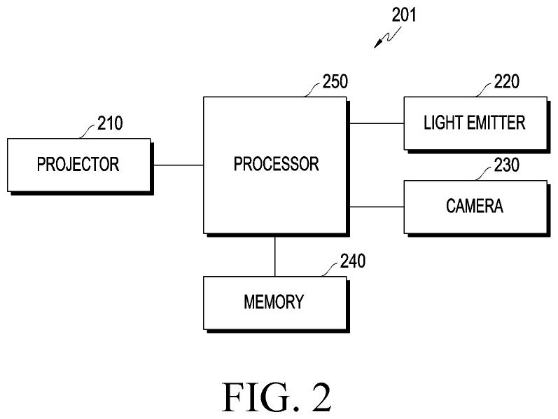

FIG. 2 is a block diagram illustrating an electronic device 201 according to an embodiment.

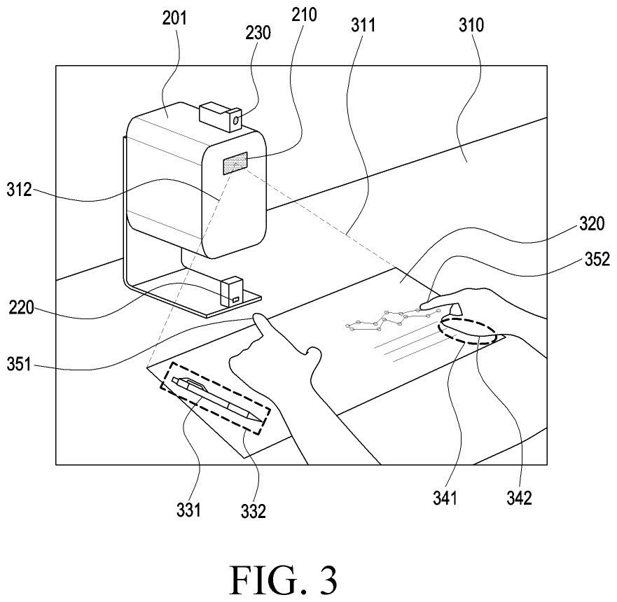

FIG. 3 is a view illustrating an electronic device 201 according to an embodiment.

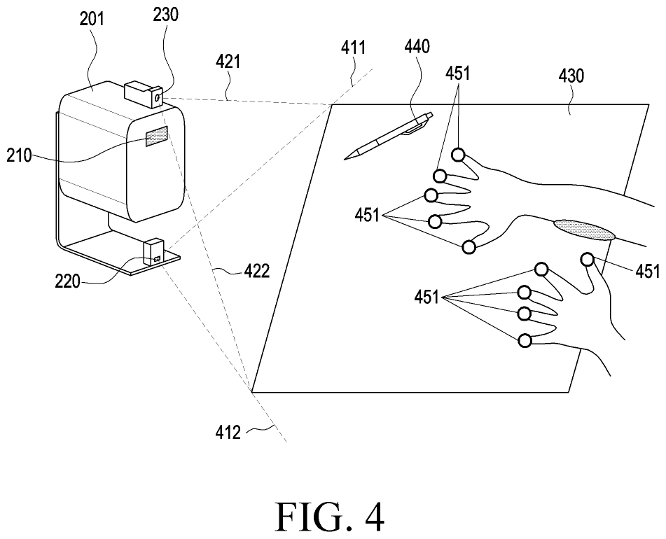

FIG. 4 is a view illustrating an electronic device 201 according to an embodiment.

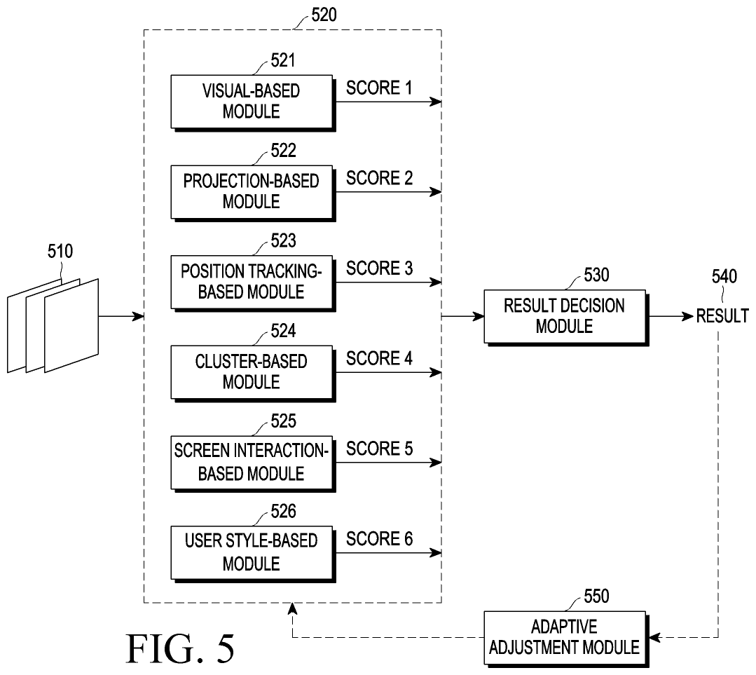

FIG. 5 is a view illustrating an electronic device 201 according to an embodiment.

Referring to FIGS. 2 to 5, in an embodiment, an electronic device 201 may include a projector 210, a light emitter 220, a camera 230, memory 240, and/or a processor 250.

In an embodiment, the projector 210 may project a screen. For example, in FIG. 3, the electronic device 201 may be placed on a table 310. The projector 210 may output a screen 320 on a surface of the table 310 by emitting light related to the screen 320 within an angle of view of the projector 210 (e.g., an angle of view determined by lines 311 and 312).

In an embodiment, as illustrated in FIG. 3, on the surface where the screen 320 is projected, not only the user's fingers 351 and 352, but also a pen 331 indicated by a dashed line 332 and the user's hand (e.g., a portion of the hand 342 except for fingers) indicated by a dashed line 341 may be disposed.

In an embodiment, the light emitter 220 may form an area for detecting user interaction with the screen by emitting light (e.g., infrared rays).

In an embodiment, the light emitter 220 may emit infrared rays. For example, as illustrated in FIG. 4, the light emitter 220 may emit infrared rays onto a surface of an object (e.g., the table 310) on which the electronic device 201 is placed.

In an embodiment, an area for detecting user interaction with the screen (hereinafter referred to as an “infrared (IR) plane”) may be formed by the infrared rays emitted from the light emitter 220. For example, in FIG. 4, an IR plane (e.g., a plane formed by lines 411 and 412) that is substantially parallel to the surface of the object (e.g., the table 310) on which the electronic device 201 is placed and the screen projected by the projector 210 may be formed by the infrared rays emitted from the light emitter 220.

In an embodiment, the camera 230 may be included in the camera module 180 of FIG. 1.

In an embodiment, the camera 230 may obtain an image by obtaining light that is emitted from the light emitter 220 and then reflected. For example, in FIG. 4, the infrared rays emitted from the light emitter 220 may be reflected by the user's finger (e.g., fingers 451) or another object (e.g., a pen 440) and then obtained by the camera 230. The camera 230 may be an IR camera that obtains an image (e.g., an infrared image) by obtaining the reflected infrared rays.

In an embodiment, in FIG. 4, reference numeral 430 may represent a plane captured by an angle of view of the camera 230 (e.g., an angle determined by lines 421 and 422). In an embodiment, the camera 230 may obtain an image of the IR plane positioned within the plane 430. For example, the camera 230 may obtain an image of an area where the plane 430 captured by the angle of view, and the IR plane overlap.

In an embodiment, in the above-described examples, the light emitter 220 is described as an IR emitter that emits infrared rays and the camera 230 is described as an IR camera, but embodiments of the present disclosure are not limited thereto. For example, the light emitter 220 may be an emitter configured to emit visible light, and the camera 230 may be a red-green-blue (RGB) camera.

In an embodiment, in the above-described examples, the camera 230 is described as including an IR camera, but embodiments of the present disclosure are not limited thereto. For example, the camera 230 may further include an RGB camera in addition to the IR camera. In an embodiment, when the camera 230 further includes an RGB camera, the electronic device 201 (e.g., the processor 250) may perform an operation of adjusting (also referred to as “calibration”) coordinates of an image obtained through the IR camera based on an image obtained through the RGB camera when converting the coordinates of the image obtained through the IR camera to coordinates of the screen projected through the projector 210. For example, the resolution, position, and size of the image obtained through the IR camera may differ from the resolution, position, and size of the screen projected through the projector 210, respectively. The electronic device 201 (e.g., the processor 250) may convert coordinates of pixels of the image obtained through the IR camera to coordinates of pixels of the projected screen by adjusting the coordinates of the pixels of the image obtained through the IR camera based on the image obtained through the RGB camera. However, the operation of converting the coordinates of the pixels of the image obtained through the IR camera to the coordinates of the pixels of the projected screen is not limited to the above-described example. Further, when the electronic device 201 is fixed to an object (e.g., a wall) and used, at least a portion of the operation of converting the coordinates of the pixels of the image obtained through the IR camera to the coordinates of the pixels of the projected screen may not be performed.

According to an embodiment, the memory 240 may be included in the memory 130 of FIG. 1.

In an embodiment, the memory 240 may store information for performing an operation of providing interaction with a projected screen.

According to an embodiment, the processor 250 may be included in the processor 120 of FIG. 1.

In an embodiment, the processor 250 may control overall operations for providing interaction with a projected screen. The processor 250 may include one or more processors for providing interaction with a projected screen.

In an embodiment, the processor 250 may obtain probabilities that a touch on the IR plane corresponds to a touch by the user's finger using a plurality of methods, and determine whether the touch on the IR plane is a touch by the user's finger based on the obtained probabilities.

In an embodiment, the touch on the IR plane may include an interaction in which at least a portion of an object intersects the IR plane. For example, the touch on the IR plane may include an interaction (or behavior) in which the user's finger or an object different from the finger intersects or contacts the IR plane formed by the light emitted by the light emitter 220.

In an embodiment, when the touch on the IR plane is a touch by the user's finger, the touch on the IR plane may be a touch intended by the user (e.g., a touch for the user to input an input to the screen) to the screen projected by the projector 210. For example, when the touch on the IR plane is a touch by the user's finger, it may be a case where the user's fingers 351 and 352 touch the projected screen 320 of FIG. 3 and a case where the user's fingers 451 touch the IR plane overlapping with the plane 430 of FIG. 4.

In an embodiment, when the touch on the IR plane is not a touch by the user's finger, the touch on the IR plane may be an unintended touch by the user. For example, when the touch on the IR plane is not a touch by the user's finger, it may be a case where the pen 331 and the user's hand (e.g., a portion of the hand 342 except for fingers) touch the projected screen 320 of FIG. 3 and a case where the pen 440 touches the IR plane overlapping with the plane 430 of FIG. 4.

Hereinafter, a touch by the user's finger on the IR plane is referred to as an “intended touch,” a “real touch,” or a “finger touch.” Further, a touch by the user's finger on the IR plane is referred to as an “unintended touch,” a “false touch,” or an “object touch.”

In an embodiment, each of the plurality of methods (hereinafter referred to as “the plurality of methods”) may be a method for determining whether a touch on the IR plane is an intended touch based on an image (e.g., an IR image) obtained through the camera 230.

In an embodiment, each of the plurality of methods may be a method for obtaining (e.g., calculating) a probability that a touch on the IR plane corresponds to an intended touch based on an image obtained through the camera 230.

In an embodiment, the processor 250 may include a plurality of modules for performing an operation of providing interaction with a projected screen. For example, as illustrated in FIG. 5, the processor 250 may include a visual-based module 521, a projection-based module 522, a position tracking-based module 523, a cluster-based module 524, a screen interaction-based module 525, a user style-based module 526, a result decision module 530, and/or an adaptive adjustment module 550.

In an embodiment, the visual-based module 521, the projection-based module

522, the position tracking-based module 523, the cluster-based module 524, the screen interaction-based module 525, the user style-based module 526, the result decision module 530, and the adaptive adjustment module 550 may each represent instructions that are stored in the memory 240 and executable individually or collectively by one or more processors 250.

In an embodiment, the plurality of methods may correspond to a plurality of modules 520, respectively. For example, the visual-based module 521, the projection-based module 522, the position tracking-based module 523, the cluster-based module 524, the screen interaction-based module 525, and the user style-based module 526 may each obtain (e.g., output) a probability that a touch on the IR plane corresponds to an intended touch based on an image (e.g., an IR image) (e.g., frames 510) obtained through the camera 230. Hereinafter, a method using the visual-based module 521 is also referred to as a “visual-based method,” a method using the projection-based module 522 is also referred to as a “projection-based method,” a method using the position tracking-based module 523 is also referred to as a “position tracking-based method,” a method using the cluster-based module 524 is also referred to as a “cluster-based method,” a method using the screen interaction-based module 525 is also referred to as a “screen interaction-based method,” and a method using the user style-based module 526 is also referred to as a “user style-based method.”

In an embodiment, the probabilities output by each of the plurality of modules 520 may be indicated as scores. For example, the scores output by the visual-based module 521, the projection-based module 522, the position tracking-based module 523, the cluster-based module 524, the screen interaction-based module 525, and the user style-based module 526 may be indicated by score 1, score 2, score 3, score 4, score 5, and score 6, respectively.

In an embodiment, the result decision module 530 may determine, as a result 540, whether the touch on the IR plane is an intended touch or an unintended touch based on the probabilities (e.g., score 1 to score 6) output by each of the plurality of modules 520.

In an embodiment, the adaptive adjustment module 550 may update the plurality of methods (e.g., the plurality of modules 520) based on the probabilities (e.g., score 1 to score 6) or the result 540.

In an embodiment, the frames 510 may represent image frames that are sequentially (e.g., continuously) obtained by the camera 230 (e.g., IR camera).

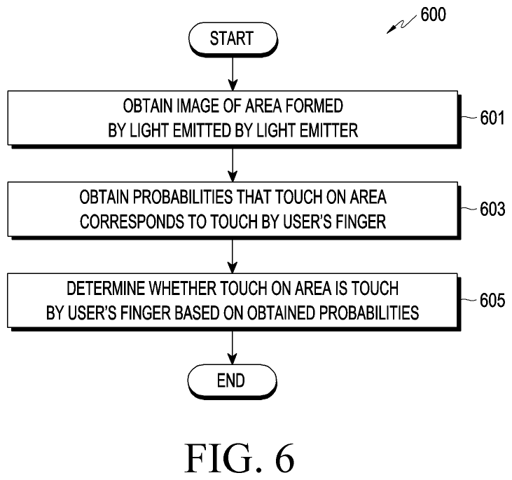

Hereinafter, with reference to FIGS. 6 to 19, operations for providing interaction with a projected screen, including operations of the plurality of modules 520, the result decision module 530, and the adaptive adjustment module 550 are described in detail.

In FIG. 2, the electronic device 201 is illustrated as including the projector 210, the light emitter 220, the camera 230, the memory 240, and the processor 250, but embodiments of the present disclosure are not limited thereto. For example, the electronic device 201 may further include the display module 160 and the communication module 190 included in the electronic device 101 of FIG. 1. When the electronic device 201 further includes the display module 160, the display module 160 may display a screen substantially identical to the screen projected by the projector 210.

FIG. 6 is a flowchart 600 illustrating a method for providing interaction with a projected screen according to an embodiment.

Referring to FIG. 6, in an operation 601, in an embodiment, the processor 250 may obtain an image of an area (IR plane) formed by light emitted by the light emitter 220 through the camera 230 while a screen is being projected by the projector 210.

In an embodiment, the processor 250 may project a screen through the projector 210 based on execution of an application for displaying the screen. For example, the processor 250 may output a screen (e.g., a video or image) through the projector 210 based on execution of an application for displaying the screen.

In an embodiment, the processor 250 may control the light emitter 220 to emit light (e.g., infrared rays) while the screen is being projected by the projector 210. A plane (e.g., IR plane) may be formed on a surface on which the electronic device 201 is placed by the light emitted by the light emitter 220.

In an embodiment, the processor 250 may obtain, through the camera 230 (e.g., IR camera), an image by obtaining light that is emitted from the light emitter 220 and then reflected.

In an embodiment, the image obtained through the camera 230 may include frames that are sequentially (e.g., continuously) obtained through the camera 230.

In an embodiment, pixel values of pixels included in the image obtained through the camera 230 may each include information about the intensity of light. For example, the pixel values of the pixels included in the image obtained through the camera 230 may each be data representing the intensity of infrared rays.

In an operation 603, in an embodiment, the processor 250 may obtain probabilities that a touch on the area (e.g., IR plane) corresponds to a touch by the user's finger using a plurality of methods based on the obtained image.

In an embodiment, the touch on the IR plane as an area formed by light emitted by the light emitter 220 may include an interaction in which at least a portion of an object intersects the IR plane. For example, the touch on the IR plane may include an interaction (or behavior) in which the user's finger or an object different from the finger intersects or contacts the IR plane formed by the light emitted by the light emitter 220.

In an embodiment, when the touch on the IR plane is a touch by the user's finger, the touch on the IR plane may be a touch intended by the user (e.g., a touch for the user to input an input to the screen) to the screen projected by the projector 210 (referred to as an “intended touch,” a “real touch,” or a “finger touch”).

In an embodiment, when the touch on the IR plane is not a touch by the user's finger, the touch on the IR plane may be an unintended touch by the user (an “unintended touch,” a “false touch,” or an “object touch”).

In an embodiment, each of the plurality of methods may be a method for determining whether a touch on the IR plane is an intended touch (or an unintended touch) based on an image (e.g., an IR image) obtained through the camera 230. For example, each of the plurality of methods may be a method for obtaining (e.g., calculating) a probability that a touch on the IR plane corresponds to an intended touch based on an image obtained through the camera 230.

In an embodiment, the plurality of methods may each correspond to the above-described plurality of modules 520. For example, the visual-based module 521, the projection-based module 522, the position tracking-based module 523, the cluster-based module 524, the screen interaction-based module 525, and the user style-based module 526 may each obtain (e.g., output) a probability that a touch on the IR plane corresponds to an intended touch based on an image (e.g., an IR image) obtained through the camera 230.

In an embodiment, the probabilities output by each of the plurality of modules 520 (hereinafter referred to as “probabilities” or “scores”) may be indicated as scores (e.g., score 1, score 2, score 3, score 4, score 5, and score 6). For example, the scores may represent the probabilities output by each of the plurality of modules 520.

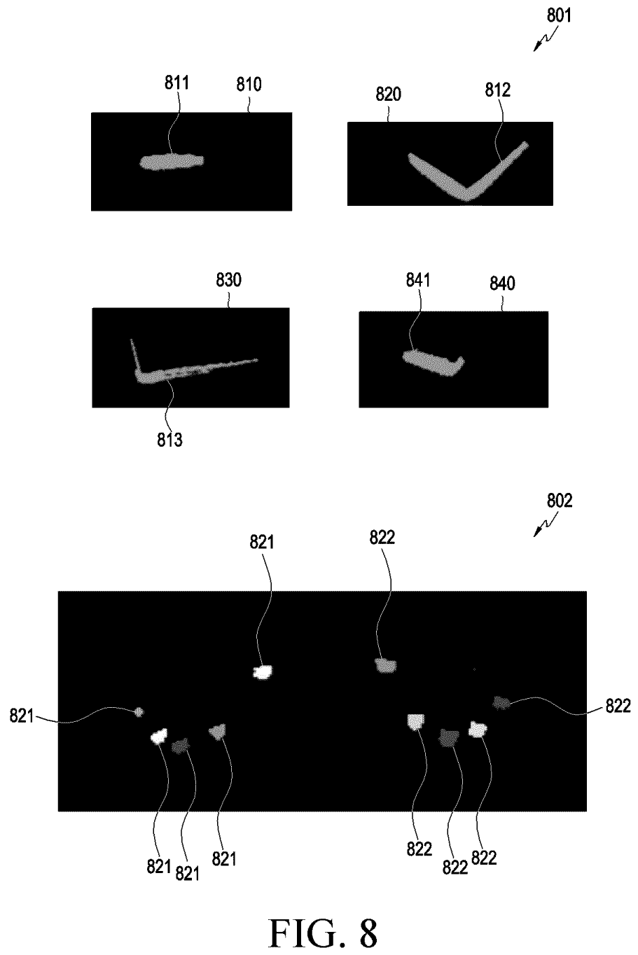

In an embodiment, operations in which each of the plurality of modules 520 (e.g., the visual-based module 521, the projection-based module 522, the position tracking-based module 523, the cluster-based module 524, the screen interaction-based module 525, and the user style-based module 526) obtains a probability are described below in detail with reference to FIGS. 8 to 19.

In an embodiment, the processor 250 may obtain a touch map (and touch position (e.g., touch coordinates)) based on an image (e.g., IR image) obtained through the camera 230. For example, the processor 250 may identify pixels having pixel values (e.g., infrared intensity equal to or larger than threshold intensity) that are equal to or larger than a threshold among all pixels included in the image obtained through the camera 230. The processor 250 may identify positions (e.g., coordinates) of the identified pixels. The processor 250 may obtain a touch map based on the identified pixels and the positions of the identified pixels. The processor 250 may obtain probabilities that a touch on the area (e.g., IR plane) corresponds to a touch by the user's finger using a plurality of methods based on the obtained touch map.

In an operation 605, in an embodiment, the processor 250 may determine whether the touch on the area (e.g., IR plane) is a touch by the user's finger based on the obtained probabilities.

In an embodiment, the processor 250 may determine whether the touch on the IR plane is a touch by the user's finger using a designated algorithm or a designated artificial intelligence model based on the obtained probabilities.

In an embodiment, the processor 250 may determine whether the touch on the IR plane is a touch by the user's finger based on the probabilities corresponding to the plurality of methods (e.g., probabilities output from each of the plurality of modules 520) and weights set for the plurality of methods (hereinafter referred to as “weights”). For example, the processor 250 may calculate a weighted average of the probabilities corresponding to the plurality of methods (e.g., an average considering the probabilities and weights corresponding to the plurality of methods) using the following Equation 1.

$$weighted average = {\sum }_{k = 1}^{n} {S}_{k} * {W}_{k} \qquad [ Equation 1 ]$$

In an embodiment, in Equation 1, n may represent the number of probabilities (e.g., scores) (or the number of the plurality of methods), Sₖ may represent the probabilities, and Wₖ may represent the weights.

In an embodiment, the processor 250 may determine whether the weighted average is equal to or larger than a threshold.

In an embodiment, the processor 250 may determine that the touch on the IR plane is a touch by the user's finger (intended touch, real touch) based on identifying that the weighted average is above the threshold. The processor 250 may determine that the touch on the IR plane is a touch by an object other than the user's finger (unintended touch, false touch) based on identifying that the weighted average is less than the threshold.

In an embodiment, the processor 250 may determine whether the touch on the IR plane is a touch by the user's finger based on whether probabilities corresponding to a designated number of methods among the plurality of methods are equal to or larger than a threshold probability among the probabilities corresponding to the plurality of methods (e.g., probabilities output from each of the plurality of modules 520). For example, the processor 250 may determine that the touch on the IR plane is a touch by the user's finger based on probabilities, 0.98 and 0.99, corresponding to two or more methods among the probabilities corresponding to the plurality of methods being equal to or larger than a threshold probability of 0.90. The processor 250 may determine that the touch on the IR plane is not a touch by the user's finger based on the number of probabilities equal to or larger than a threshold probability of 0.90 among the probabilities corresponding to the plurality of methods being less than two. In the above-described examples, the threshold probability is described as being set to one threshold probability such as 0.90, but embodiments of the present disclosure are not limited thereto. For example, the threshold probability compared with the probabilities corresponding to the plurality of methods may be set differently for at least some of the plurality of methods.

In an embodiment, when the touch on the IR plane includes a plurality of touches, the processor 250 may perform the above-described operations 603 and 605 for each of the plurality of touches. For example, when the touch on the IR plane includes a plurality of touches, the processor 250 may determine whether each of the plurality of touches is a touch by the user's finger by performing operations 603 and 605.

In an embodiment, when determining that the touch on the IR plane is not a touch by a finger, the processor 250 may disregard the touch on the IR plane. For example, when determining that the touch on the IR plane is not a touch by a finger, the processor 250 may prevent a function of the electronic device 201 from being executed based on the touch on the IR plane. For example, when determining that the touch on the IR plane is not a touch by a finger, the processor 250 may determine that an event related to a touch for executing a function of the electronic device 201 has not occurred.

In an embodiment, when determining that the touch on the IR plane is a touch by a finger, the processor 250 may execute a function of the electronic device 201 corresponding to the touch on the IR plane. For example, when determining that the touch on the IR plane is a touch by a finger, the processor 250 may identify a position (e.g., coordinates) corresponding to the touch on the IR plane. The processor 250 may execute a function mapped to the icon based on the position (e.g., coordinates) corresponding to the touch on the IR plane corresponding to a position of an icon included in the screen projected by the projector 210.

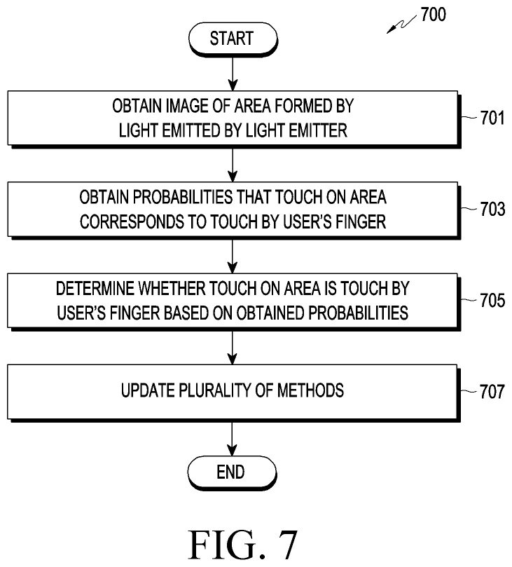

FIG. 7 is a flowchart 700 illustrating a method for providing interaction with a projected screen according to an embodiment.

Referring to FIG. 7, in an operation 701, in an embodiment, the processor 250 may obtain an image of an area formed by light emitted by the light emitter 220 through the camera 230 while a screen is being projected by the projector 210.

The operation 701 may be at least partially identical or similar to the operation 601 of FIG. 6, so a repeated description thereof may be omitted.

In an operation 703, in an embodiment, the processor 250 may obtain probabilities that a touch on the area (e.g., IR plane) corresponds to a touch by the user's finger using a plurality of methods based on the obtained image.

The operation 703 may be at least partially identical or similar to the operation 603 of FIG. 6, so a repeated description thereof may be omitted.

In an operation 705, in an embodiment, the processor 250 may determine whether the touch on the area (e.g., IR plane) is a touch by the user's finger based on the obtained probabilities.

Since the operation 705 may be at least partially the same as or similar to operation 605 of FIG. 6, a repeated description thereof may be omitted.

In an operation 707, in an embodiment, the processor 250 may update the plurality of methods based on the result of operation 705.

In an embodiment, the processor 250 (e.g., the adaptive adjustment module 550) may update the plurality of modules 520 corresponding to the plurality of methods based on the result of whether the touch on the area (e.g., IR plane) is a touch by the user's finger.

In an embodiment, each of the plurality of modules 520 corresponding to the plurality of methods may include an artificial intelligence model for obtaining a probability. The processor 250 may update weights included in at least some of the plurality of modules 520 using the result of whether the touch on the area (e.g., IR plane) is a touch by the user's finger (hereinafter also referred to as “result”) as a ground truth. For example, the processor 250 may sequentially (or continuously) obtain IR images through the camera 230 (e.g., IR camera). The processor 250 may determine whether the touch on the area (e.g., IR plane) is a touch by the user's finger at each time when the IR images are obtained by performing the operations 703 to 705 for each of the sequentially obtained IR images. The processor 250 may update weights (e.g., weights included in at least some of the plurality of modules 520) to be used in an operation of obtaining a result based on a current image using a result determined based on a previously obtained image as the ground truth.

In an embodiment, the processor 250 may train weights for each of the plurality of modules 520 based on a backpropagation function using the result as the ground truth. The trained weights may be used when performing the operations 703 and 705 based on a next frame (e.g., an IR image frame obtained after an IR image frame obtained through the camera 230). For example, the visual-based module 521 may output 0.3 as score 1, the projection-based module 522 may output 0.7 as score 2, and the position tracking-based module may output 0.9 as score 3. The processor 250 may determine that the touch on the area (e.g., IR plane) is a touch by the user's finger based on 0.3, 0.7, and 0.9 as score 1, score 2, and score 3. In this case, the processor 250 may adjust weights of the visual-based module 521 that outputs score 1 using the touch on the area (e.g., IR plane) being an intended touch as the ground truth.

In an embodiment, the processor 250 may update the result decision module 530 based on the result of whether the touch on the area (e.g., IR plane) is a touch by the user's finger.

In an embodiment, the result decision module 530 may include an artificial intelligence model for obtaining a result (e.g., the result of the operation 705). For example, the processor 250 may update weights included in the result decision module 530 using the result of whether the touch on the area (e.g., IR plane) is a touch by the user's finger as the ground truth.

In an embodiment, the processor 250 may adjust the weight Wₖ of the above-described Equation 1 using the result as the ground truth. For example, when the probability (score 1) of the visual-based module 521 is 0.98, the probability (score 2) of the projection-based module 522 is 0.8, and the result is an intended touch, the processor 250 may update a value obtained by multiplying the weight W₂ corresponding to the probability (score 2) of the projection-based module 522 by 1.05 as a weight included in the projection-based module 522.

In an embodiment, in the above-described examples, weights of the plurality of modules 520 and/or the result decision module 530 are described as being updated, but embodiments of the present disclosure are not limited thereto. For example, the processor 250 may update at least some of thresholds related to the plurality of modules 520 and/or the result decision module 530 (e.g., a threshold compared with the weighted average of Equation 1, or the above-described threshold probability). For example, the processor 250 may update parameters related to the plurality of modules 520 and/or the result decision module 530 (e.g., the number of samples (e.g., data) used by the plurality of modules 520 and/or the result decision module 530 to output a result).

Hereinafter, operations of obtaining probabilities in the visual-based module 521, the projection-based module 522, the position tracking-based module 523, the cluster-based module 524, the screen interaction-based module 525, and the user style-based module 526 are described with reference to FIGS. 8 to 19.

FIG. 8 is a view illustrating a method for obtaining a probability that a touch on an IR plane corresponds to an intended touch using a visual-based method according to an embodiment.

Referring to FIG. 8, in an embodiment, the processor 250 may obtain a probability that a touch on the IR plane corresponds to an intended touch based on a size of a touched area (e.g., an area of a finger or object that intersects the IR plane) on the IR plane (hereinafter referred to as a “touched area”), a length of the touched area, and/or a change in the touched area based on an image of the IR plane (e.g., an IR image obtained through an IR camera).

In an embodiment, when the size of the touched area on the IR plane is larger than a threshold size, the processor 250 may determine that the touch on the IR plane corresponds to an unintended touch.

In an embodiment, when the size of the touched area on the IR plane is larger than a threshold size, the processor 250 may determine a probability that the touch on the IR plane corresponds to an intended touch as a lower value.

In an embodiment, when the length of the touched area on the IR plane is longer than a threshold length, the processor 250 may determine that the touch on the IR plane corresponds to an unintended touch.

In an embodiment, when the length of the touched area on the IR plane is longer than a threshold length, the processor 250 may determine a probability that the touch on the IR plane corresponds to an intended touch as a lower value.

In an embodiment, the processor 250 may obtain a shape of the touched area based on a change in the touched area. The processor 250 may obtain a similarity between the obtained shape of the touched area and a shape stored in the memory 240. The processor 250 may determine a probability that the touch on the IR plane corresponds to an intended touch based on the similarity. For example, the processor 250 may determine a probability that the touch on the IR plane corresponds to an intended touch as a higher value as the similarity increases.

In an embodiment, the processor 250 may obtain a position change of the touched area based on a change in the touched area. The processor 250 may determine that the touch on the IR plane corresponds to an unintended touch based on the obtained position change of the touched area being less than a threshold change. For example, while a finger may be moved on the IR plane, an object (e.g., a pen) may be placed on the IR plane without movement. The processor 250 may determine a probability that the touch on the IR plane corresponds to an intended touch as a lower value based on the obtained position change of the touched area being less than a threshold change. The processor 250 may determine a probability that the touch on the IR plane corresponds to an intended touch as a higher value based on the obtained position change of the touched area being equal to or larger than a threshold change.

In an embodiment, reference numeral 801 of FIG. 8 may represent images 810, 820, 830, and 840 in which unintended touches are detected on the IR plane. In the images 810, 820, 830, and 840, touched areas 811, 812, 813, and 814 are shown.

In an embodiment, reference numeral 802 in FIG. 8 may represent an image 850 in which an intended touch is detected on the IR plane. Reference numerals 821 and 822 in the image 850 may represent areas touched by fingers.

In an embodiment, the processor 250 may calculate a probability that a touch corresponding to a touched area corresponds to an intended touch for each of the touched areas 811, 812, 813, 814, 821, and 822 based on a touched size, a length of the touched area, and/or a change in the touched area.

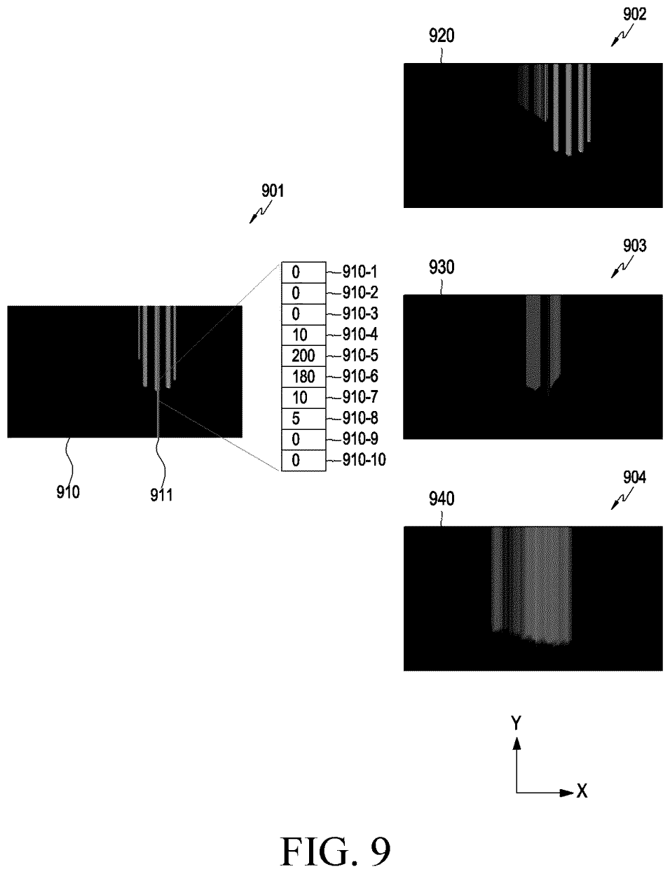

FIG. 9 is a view illustrating a method for obtaining a probability that a touch on an IR plane corresponds to an intended touch using a projection-based method according to an embodiment.

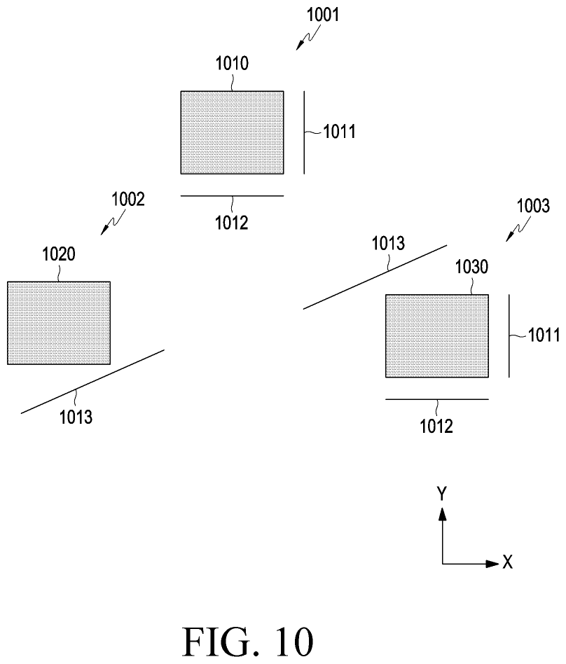

FIG. 10 is a view illustrating a method for obtaining a probability that a touch on an IR plane corresponds to an intended touch using a projection-based method according to an embodiment.

Referring to FIGS. 9 and 10, in an embodiment, pixel values of pixels included in an image obtained through the camera 230 may each include information about the intensity of light. For example, the pixel values of the pixels included in the image obtained through the camera 230 may each be data representing the intensity of infrared rays.

In an embodiment, the processor 250 may obtain a plurality of maximum pixel values and positions of rows corresponding to the plurality of maximum pixel values by obtaining a maximum pixel value and a position of a row corresponding to the maximum pixel value for each of columns of pixels of the image. The processor 250 may obtain a probability that the touch on the IR plane corresponds to a touch by the finger based on the plurality of maximum pixel values and the positions of the rows corresponding to the plurality of maximum pixel values.

In an embodiment, in reference numeral 901 of FIG. 9, an image 910 may represent an image obtained through the camera 230 when the user's finger touches the IR plane. The processor 250 may obtain a maximum value and a position of a row (or row index) where the maximum value is obtained for pixel values of the image 910 by column. For example, the processor 250 may obtain a maximum value of pixel value 200 910-5 and a position of a row where the pixel value 200 910-5 is obtained (e.g., a fifth position from the top of the image 910) among pixel values of a column 911 (e.g., values indicated by 910-1, 910-2, 910-3, 910-4, 910-5, 910-6, 910-7, 910-8, 910-9, and 910-10).

In an embodiment, the processor 250 may obtain a probability that a touch on the IR plane corresponds to an intended touch by comparing the plurality of maximum pixel values and the positions of the rows corresponding to the plurality of maximum pixel values according to the columns with values stored (or registered) in the memory 240.

In an embodiment, in reference numeral 901, the image 910 may represent an image obtained through the camera 230 when five fingers of the user touch the IR plane.

In an embodiment, in reference numeral 902, an image 920 may represent an image obtained through the camera 230 when five fingers of the user and a sleeve touch the IR plane.

In an embodiment, in reference numeral 903, an image 930 may represent an image obtained through the camera 230 when five fingers of the user touch the IR plane when the IR plane formed by the light emitter 220 is not parallel to a surface on which the electronic device 201 is placed.

In an embodiment, in reference numeral 904, an image 940 may represent an image obtained through the camera 230 when a mobile phone is placed on the IR plane.

In an embodiment, the case of obtaining a maximum value of pixel values and a position of a row corresponding to the maximum value by column of pixels of an image described through FIG. 9 may be represented as projecting pixel values of the pixels of the image onto an X-axis (e.g., an axis perpendicular to the column).

In an embodiment, in reference numeral 1001 of FIG. 10, the processor 250 may project pixel values of the pixels of the image onto a line 1012 corresponding to the X-axis and a line 1011 corresponding to the Y-axis.

In an embodiment, in reference numeral 1002 of FIG. 10, the processor 250 may project pixel values of the pixels of the image onto a line 1013 corresponding to an axis different from the X-axis and Y-axis.

In an embodiment, in reference numeral 1003 of FIG. 10, the processor 250 may project pixel values of the pixels of the image onto the line 1012 corresponding to the X-axis, the line 1011 corresponding to the Y-axis, and the line 1013 corresponding to an axis different from the X-axis and Y-axis.

In an embodiment, the processor 250 may obtain a probability that a touch on the IR plane corresponds to an intended touch by comparing values obtained through the projection (e.g., a maximum value of pixel values and a position of a row corresponding to the maximum value by column of pixels of the image when pixel values are projected onto the X-axis) with values stored in the memory 240.

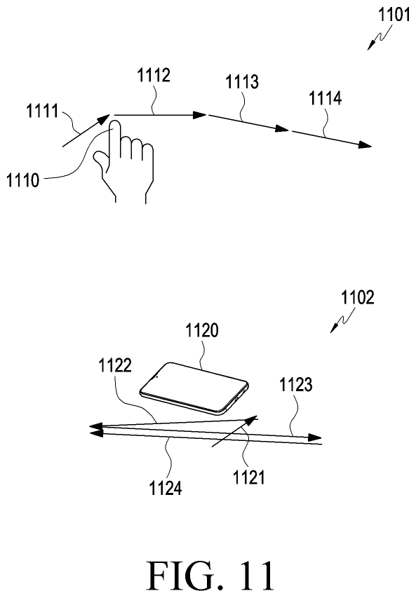

FIG. 11 is a view illustrating a method for obtaining a probability that a touch on an IR plane corresponds to an intended touch using a position tracking-based method according to an embodiment.

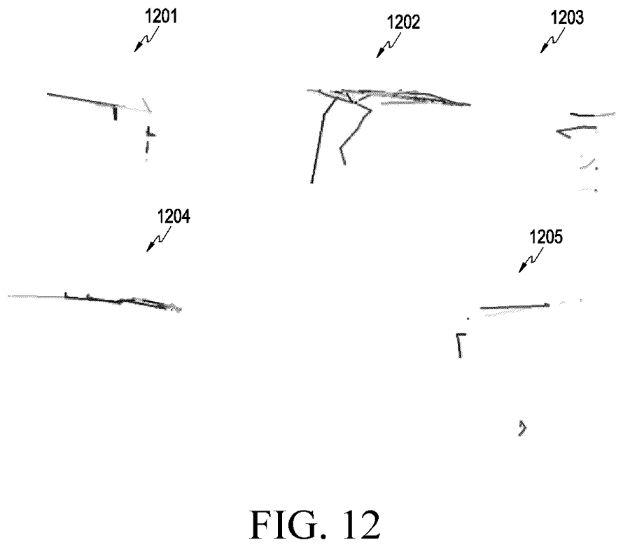

FIG. 12 is a view illustrating a method for obtaining a probability that a touch on an IR plane corresponds to an intended touch using a position tracking-based method according to an embodiment.

Referring to FIGS. 11 and 12, in an embodiment, the processor 250 may obtain a probability that a touch on the IR plane corresponds to an intended touch based on a trajectory of the touch on the IR plane.

In an embodiment, the processor 250 may obtain a trajectory of the touch on the IR plane based on images sequentially (e.g., continuously) obtained through the camera 230.

In an embodiment, when the touch on the IR plane is a touch that is not a touch by the user's finger (hereinafter referred to as “touch by an object”) and when the touch on the IR plane is a touch by the user's finger (hereinafter referred to as “touch by a finger”), a moving speed of the trajectory of the touch and the number of direction changes of the trajectory of the touch may be different.

In an embodiment, reference numeral 1101 of FIG. 11 may represent a trajectory of a touch by a finger 1110. Reference numeral 1102 in FIG. 11 may represent a trajectory of a touch by an object 1120 (e.g., a mobile phone).

In an embodiment, in reference numeral 1101, as illustrated by arrows 1111, 1112, 1113, and 1114 representing the trajectory of the touch by the finger 1110, the speed of the trajectory of the touch by the finger 1110 may be below a designated speed (e.g., a pre-defined speed), and the number of direction changes in the trajectory of the touch by the finger 1110 may be below a designated number (e.g., a pre-defined number).

In an embodiment, in reference numeral 1102, as illustrated by arrows 1121, 1122, 1123, and 1124 representing the trajectory of the touch by the object 1120, the speed of the trajectory of the touch by the object 1120 may be equal to or larger than a designated speed (e.g., a pre-defined speed), and the number of direction changes in the trajectory of the touch by the object 1120 may be equal to or larger than a designated number (e.g., a pre-defined number).

In an embodiment, the processor 250 may obtain a probability that a touch on the IR plane corresponds to an intended touch based on a moving speed and/or the number of direction changes of a trajectory of the touch on the IR plane. For example, the processor 250 may determine a probability that a touch on the IR plane corresponds to an intended touch as a lower value as the moving speed of the trajectory of the touch on the IR plane increases. For example, the processor 250 may determine a probability that a touch on the IR plane corresponds to an intended touch as a lower value as the number of direction changes of the trajectory of the touch on the IR plane increases.

In an embodiment, reference numerals 1201, 1202, 1203, 1204, and 1205 in FIG. 12 may represent cases (e.g., trajectories) where touches on the IR plane are unintended touches.

In an embodiment, unintended touches on the IR plane may have higher jittering in comparison to intended touches. In an embodiment, as illustrated in FIG. 12, unintended touches on the IR plane may have more unpredictable movements in comparison to intended touches.

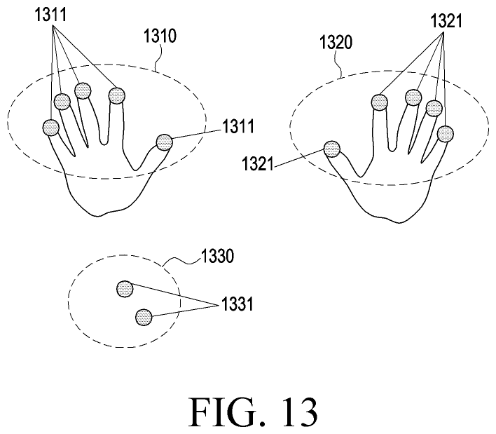

FIG. 13 is a view illustrating a method for obtaining a probability that a touch on an IR plane corresponds to an intended touch using a cluster-based method according to an embodiment.

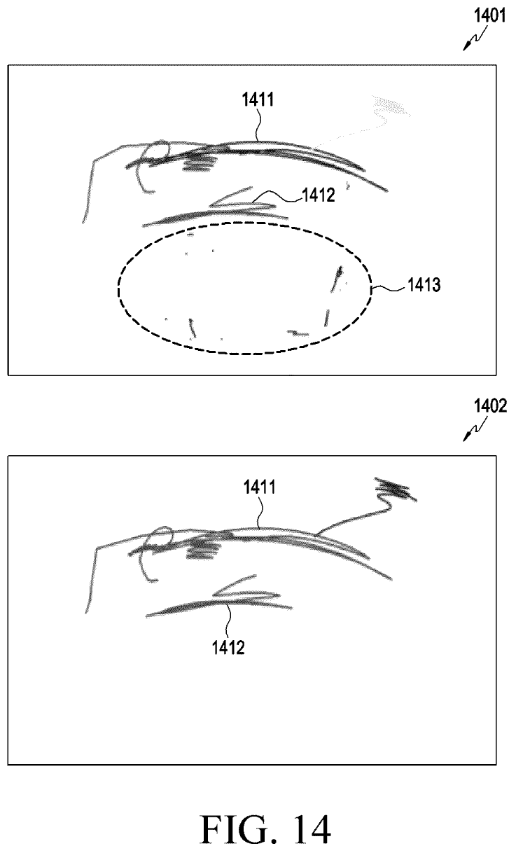

FIG. 14 is a view illustrating a method for obtaining a probability that a touch on an IR plane corresponds to an intended touch using a cluster-based method according to an embodiment.

Referring to FIGS. 13 and 14, in an embodiment, the processor 250 may classify touches whose distances between touched positions are equal to or less than a designated distance (e.g., a pre-defined distance) as one cluster. For example, the processor 250 may group touches whose distances between touched positions are equal to or less than a designated distance (e.g., a pre-defined distance) into the same group.

In an embodiment, FIG. 13 may represent positions 1311 of fingers of the user's left hand (e.g., positions of fingers touching the IR plane), positions 1321 of fingers of the user's right hand, and positions 1331 of an object (e.g., positions of an object touching the IR plane).

In an embodiment, in FIG. 13, the processor 250 may identify three clusters (also referred to as “three groups”) based on distances between the positions 1311, the positions 1321, and the positions 1331.

In an embodiment, when three or more clusters are identified, the processor 250 may determine touches corresponding to two clusters among the three or more clusters as intended touches and determine touches corresponding to the remaining clusters as unintended touches.

In an embodiment, as illustrated in FIG. 13, since the user has two hands, it may be difficult for three or more clusters to correspond to two hands. Accordingly, when three or more clusters are identified, the three or more clusters may include touches by objects other than the user's fingers.

In an embodiment, when three or more clusters are identified, the processor 250 may determine whether a cluster is a cluster including touches by the user's fingers or a cluster including touches by objects other than fingers based on areas of touches included in each cluster. The processor 250 may obtain a probability that each of the touches included in the clusters, other than a cluster including touches by objects other than fingers, among the three or more clusters corresponds to an intended touch.

In an embodiment, with reference to FIG. 14, an image 1401 may include a first cluster 1411, a second cluster 1412, and a third cluster 1413. The processor 250 may exclude the third cluster 1413 as illustrated with reference numeral 1402 of FIG. 14. The processor 250 may obtain a probability that each of the touches included in the first cluster 1411 and the second cluster 1412 corresponds to an intended touch based on the first cluster 1411 and the second cluster 1412.

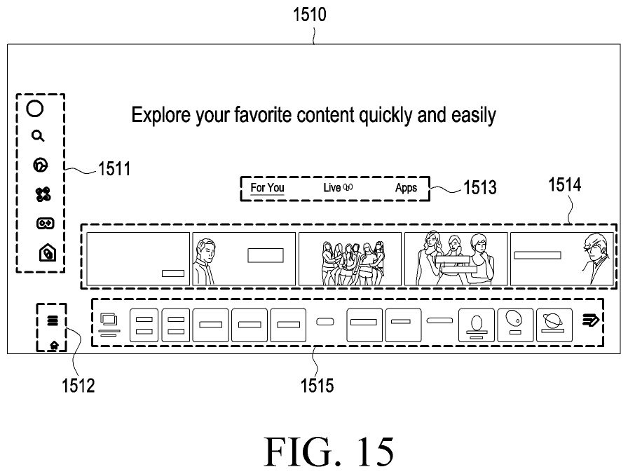

FIG. 15 is a view illustrating a method for obtaining a probability that a touch on an IR plane corresponds to an intended touch using a screen interaction-based method according to an embodiment.

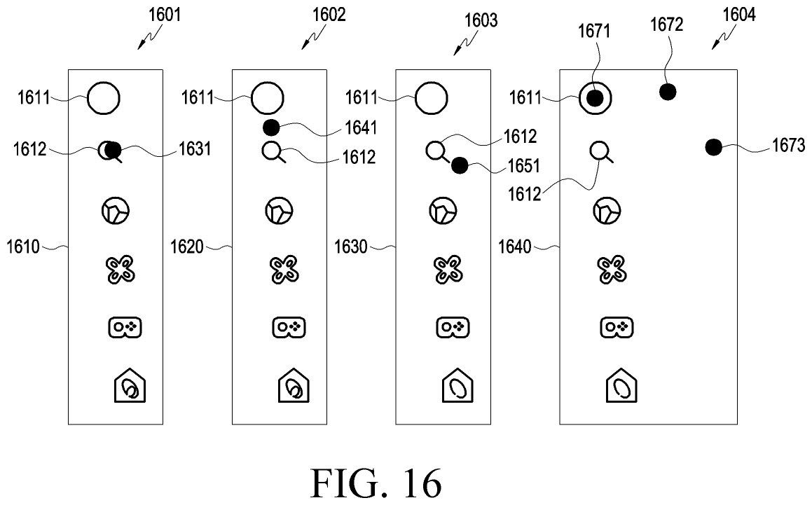

FIG. 16 is a view illustrating a method for obtaining a probability that a touch on an IR plane corresponds to an intended touch using a screen interaction-based method according to an embodiment.

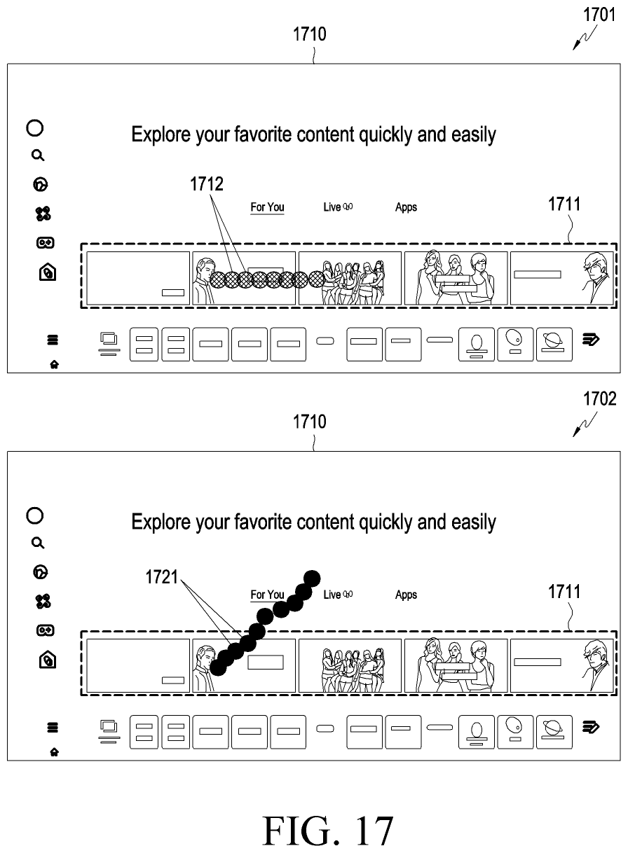

FIG. 17 is a view illustrating a method for obtaining a probability that a touch on an IR plane corresponds to an intended touch using a screen interaction-based method according to an embodiment.

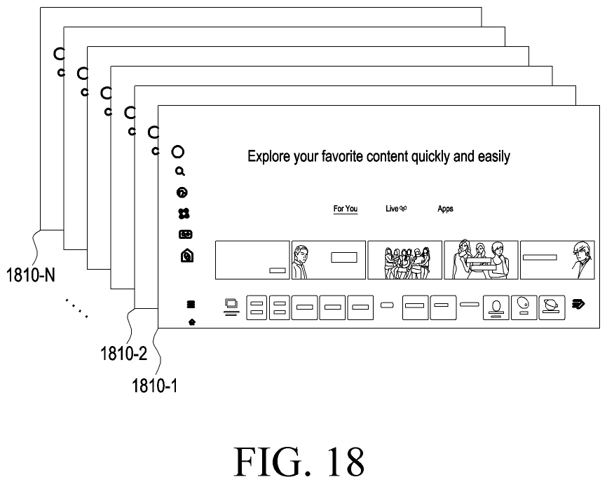

FIG. 18 is a view illustrating a method for obtaining a probability that a touch on an IR plane corresponds to an intended touch using a screen interaction-based method according to an embodiment.

Referring to FIGS. 15 to 18, in an embodiment, FIG. 15 may represent a screen 1510 projected by the projector 210.

In an embodiment, the screen 1510 may include a plurality of areas 1511, 1512, 1513, 1514, and 1515 capable of interacting with the user. The area 1511, the area 1512, and the area 1513 may include objects (e.g., buttons, icons) capable of performing functions based on being touched. The area 1515 and the area 1516 may be areas including objects scrollable by drag or swipe.

In an embodiment, the processor 250 may obtain a probability that a touch on the IR plane corresponds to an intended touch based on a distance between an object (e.g., button, icon) included in the screen and a touched area on the IR plane.

In an embodiment, in reference numeral 1601 of FIG. 16, a portion 1610 of the screen may include buttons (e.g., buttons 1611 and 1612). The processor 250 may determine a probability that a touch corresponding to the touched area 1631 corresponds to an intended touch as a higher value based on the button 1612 and the touched area 1631 substantially overlapping. The processor 250 may determine that a touch corresponding to the touched area 1631 is an intended touch based on the button 1612 and the touched area 1631 substantially overlapping.

In an embodiment, in reference numeral 1602 of FIG. 16, a portion 1620 of the screen may include buttons (e.g., buttons 1611 and 1612). The processor 250 may determine a probability that a touch corresponding to the touched area 1631 corresponds to an intended touch as a lower value based on the touched area 1641 being present between the button 1611 and the button 1612 (or based on distances between the button 1611 and the button 1612 and the touched area 1641). The processor 250 may determine that a touch corresponding to the touched area 1631 is an unintended touch based on the touched area 1641 being present between the button 1611 and the button 1612.

In an embodiment, in reference numeral 1603 of FIG. 16, a portion 1630 of the screen may include buttons (e.g., buttons 1611 and 1612). The processor 250 may determine a probability that a touch corresponding to the touched area 1641 corresponds to an intended touch as a lower value based on a distance between the button 1612 and the touched area 1651. The processor 250 may determine that a touch corresponding to the touched area 1641 is an unintended touch based on a distance between the button 1612 and the touched area 1651.

In an embodiment, in reference numeral 1604 of FIG. 16, a portion 1640 of the screen may include buttons (e.g., buttons 1611 and 1612). The processor 250 may determine probabilities that touches corresponding to the touched areas 1671, 1672, and 1673 correspond to intended touches as lower values based on the presence of touch areas 1672 and 1673 that do not overlap buttons, even though the button 1612 and the touched area 1671 substantially overlap. The processor 250 may determine that touches corresponding to the touched areas 1671, 1672, and 1673 are unintended touches based on the presence of touch areas 1672 and 1673 that do not overlap buttons, even though the button 1612 and the touched area 1671 substantially overlap.

In an embodiment, the processor 250 may obtain a probability that a touch on the IR plane corresponds to an intended touch based on whether the touch on the IR plane corresponds to a touch capable of performing a function related to an area included in the screen. For example, in reference numerals 1701 and 1702 of FIG. 17, an area 1711 included in a screen 1710 may include objects scrollable in left and right directions by left and right drags. The processor 250 may determine that the touch 1712 corresponds to a touch capable of performing a scroll function as a function related to the area 1711 when the touch 1712 is a drag in the right direction, as illustrated in reference numeral 1701 of FIG. 17. The processor 250 may determine that the touch 1721 does not correspond to a touch capable of performing a scroll function as a function related to the area 1711 when the touch 1721 is a drag in the right and upper directions, as illustrated by reference numeral 1702 of FIG. 17.

In an embodiment, the processor 250 may determine a probability that a touch on the IR plane corresponds to an intended touch as a higher value based on the touch on the IR plane corresponding (or more closely corresponding) to a touch capable of performing a function related to an area included in the screen. The processor 250 may determine a probability that a touch on the IR plane corresponds to an intended touch as a lower value based on the touch on the IR plane not corresponding to a touch capable of performing a function related to an area included in the screen. For example, based on a direction of movement of the touch (e.g., the touch 1712 and the touch 1721) more closely corresponding to a touch direction for performing the function (e.g., the scroll function), the processor 250 may determine that the value of the probability is higher.

In an embodiment, in the examples described with reference to FIG. 17, it was assumed that a touch capable of performing a function related to an area included in the screen is known (e.g., a touch capable of performing a function related to an area included in the screen is stored in the memory 240), but there may be cases where a touch capable of performing a function related to an area included in the screen is not known. In such cases, the processor 250 may set a touch capable of performing a function related to an area included in the screen based on touches of a plurality of users on the screen. For example, with reference to FIG. 18, the processor 250 may receive information 1810-1, 1810-2, and 1810-N related to touches of a plurality of users corresponding to external electronic devices for the same area of the screen from the external electronic devices through a communication circuit. The processor 250 may set a touch capable of performing a function related to an area included in the screen based on the information 1810-1, 1810-2, and 1810-N. The processor 250 may determine whether an area included in the screen is an area capable of performing a function by touch down and whether an area included in the screen is an area capable of performing a function by drag in a specific direction based on the information 1810-1, 1810-2, and 1810-N.

In an embodiment, after setting a touch capable of performing a function related to an area included in the screen, the processor 250 may perform the examples described with reference to FIGS. 16 and/or 17.

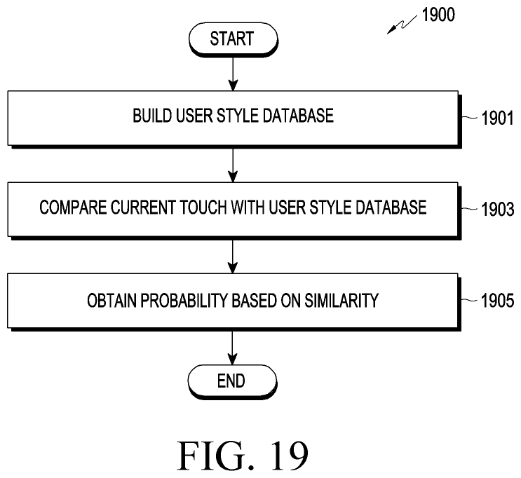

FIG. 19 is a flowchart 1900 illustrating a method for obtaining a probability that a touch on an IR plane corresponds to an intended touch using a user style-based method according to an embodiment.

Referring to FIG. 19, in an operation 1901, in an embodiment, the processor 250 may build a user style database.

In an embodiment, the processor 250 may analyze the user's style related to touches on the IR plane that were previously detected. For example, the processor 250 may analyze touch shape, touch intensity, touch speed, and/or touch trajectory of touches on the IR plane that were previously detected. The processor 250 may build a database related to the user's touch on the IR plane (hereinafter referred to as “user style database”) based on touch shape, touch intensity (e.g., maximum touch intensity), touch speed, and/or touch trajectory of touches on the IR plane that were previously detected.

In an embodiment, the user style database may include information about touch shape, touch intensity, touch speed, and/or touch trajectory of touches on the IR plane that were previously detected.

In an operation 1903, in an embodiment, the processor 250 may compare a current touch on the IR plane with the user style database. For example, the processor 250 may obtain a similarity between the current touch on the IR plane and the user style database.

In an operation 1905, in an embodiment, the processor 250 may obtain a probability that the touch on the IR plane corresponds to an intended touch based on the similarity.

According to an embodiment of the present disclosure, An electronic device may include a projector configured to project a screen, a light emitter, a camera, and at least one processor. The at least one processor may be configured to obtain an image of an area formed by light emitted by the light emitter through the camera while the screen is projected by the projector. The at least one processor may be configured to obtain probabilities that a touch on the area corresponds to a touch by a user's finger using a plurality of methods based on the obtained image. The at least one processor may be configured to determine whether the touch on the area is the touch by the user's finger based on the obtained probabilities.

In an embodiment, the at least one processor may be configured to identify whether a value, obtained based on the obtained probabilities and weights respectively set for the plurality of methods, is equal to or larger than a threshold, determine that the touch on the area is the touch by the finger based on identifying that the value is equal to or larger than the threshold, and determine that the touch on the area is not the touch by the finger based on identifying that the value is less than the threshold.

In an embodiment, the at least one processor may be configured to determine whether the touch on the area is the touch by the finger based on whether probabilities, corresponding to a designated number of methods among the plurality of methods, among the obtained probabilities are equal to or larger than a threshold probability.

In an embodiment, the at least one processor may be configured to perform a function of the electronic device based on the touch on the area based on determining that the touch on the area is the touch by the finger, and disregard the touch on the area based on determining that the touch on the area is not the touch by the finger.

In an embodiment, the at least one processor may be configured to update weights related to at least a portion of the plurality of methods using a result of whether the touch on the area is a touch by the user's finger as ground truth.

In an embodiment, the at least one processor may be configured to obtain a position change of an area of the touch on the area based on the obtained image, determine a probability that the touch on the area corresponds to the touch by the finger as a higher value based on the position change being equal to or larger than a threshold change, and determine the probability that the touch on the area corresponds to the touch by the finger as a lower value based on the position change being less than the threshold change.

In an embodiment, the at least one processor may be configured to obtain a plurality of maximum pixel values and positions of rows corresponding to the plurality of maximum pixel values by obtaining a maximum pixel value and a position of a row corresponding to the maximum pixel value for each of columns of pixels of the obtained image, and obtain a probability that the touch on the area corresponds to the touch by the finger based on the plurality of maximum pixel values and the positions of the rows corresponding to the plurality of maximum pixel values.

In an embodiment, the at least one processor may be configured to obtain a moving speed of a trajectory of the touch on the area and a number of direction changes of the touch on the area, and obtain a probability that the touch on the area corresponds to the touch by the finger based on the moving speed and the number of direction changes.

In an embodiment, the at least one processor may be configured to obtain a probability that the touch on the area corresponds to the touch by the finger based on a distance between an object included in the screen and an area of the touch on the area.

In an embodiment, the at least one processor may be configured to obtain a probability that the touch on the area corresponds to the touch by the finger based on a touch shape, touch intensity, touch speed, and touch trajectory of the user's touches previously detected for the area.

According to an embodiment of the present disclosure, a method for providing interaction with a screen projected from an electronic device may include obtaining an image of an area formed by light emitted by a light emitter of the electronic device through a camera of the electronic device while the screen is projected by a projector of the electronic device. The method may include obtaining probabilities that a touch on the area corresponds to a touch by a user's finger using a plurality of methods based on the obtained image. The method may include determining whether the touch on the area is the touch by the user's finger based on the obtained probabilities.

In an embodiment, determining whether the touch on the area is the touch by the user's finger may include identifying whether a value, obtained based on the obtained probabilities and weights respectively set for the plurality of methods, is equal to or larger than a threshold, determining that the touch on the area is the touch by the finger based on identifying that the value is equal to or larger than the threshold, and determining that the touch on the area is not the touch by the finger based on identifying that the value is less than the threshold.

In an embodiment, determining whether the touch on the area is the touch by the user's finger may include determining whether the touch on the area is the touch by the finger based on whether probabilities, corresponding to a designated number of methods among the plurality of methods, among the obtained probabilities are equal to or larger than a threshold probability.

In an embodiment, the method may further include performing a function of the electronic device based on the touch on the area based on determining that the touch on the area is the touch by the finger, and disregarding the touch on the area based on determining that the touch on the area is not the touch by the finger.

In an embodiment, the method may further include updating weights related to at least a portion of the plurality of methods using a result of whether the touch on the area is a touch by the user's finger as ground truth.

In an embodiment, obtaining the probabilities may include obtaining a position change of an area of the touch on the area based on the obtained image, determining a probability that the touch on the area corresponds to the touch by the finger as a higher value based on the position change being equal to or larger than a threshold change, and determining the probability that the touch on the area corresponds to the touch by the finger as a lower value based on the position change being less than the threshold change.

In an embodiment, obtaining the probabilities may include obtaining a plurality of maximum pixel values and positions of rows corresponding to the plurality of maximum pixel values by obtaining a maximum pixel value and a position of a row corresponding to the maximum pixel value for each of columns of pixels of the obtained image, and obtaining a probability that the touch on the area corresponds to the touch by the finger based on the plurality of maximum pixel values and the positions of the rows corresponding to the plurality of maximum pixel values.

In an embodiment, obtaining the probabilities may include obtaining a moving speed of a trajectory of the touch on the area and a number of direction changes of the touch on the area, and obtaining a probability that the touch on the area corresponds to the touch by the finger based on the moving speed and the number of direction changes.

In an embodiment, obtaining the probabilities may include obtaining a probability that the touch on the area corresponds to the touch by the finger based on a distance between an object included in the screen and an area of the touch on the area.

In an embodiment, obtaining the probabilities may include obtaining a probability that the touch on the area corresponds to the touch by the finger based on a touch shape, touch intensity, touch speed, and touch trajectory of the user's touches previously detected for the area.

Further, the structure of the data used in embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a CD-ROM or a DVD).

What is claimed is:

1. An electronic device comprising:
a projector configured to project a screen;
a light emitter;
a camera; and
at least one processor configured to:
while the screen is projected by the projector, obtain, through the camera, an image of an area formed by light emitted by the light emitter,
based on the obtained image, obtain, using a plurality of methods, probabilities that a touch on the area corresponds to a touch by a finger of a user, wherein the probabilities are obtained based on performing the plurality of methods, respectively, and
based on the obtained probabilities, determine whether the touch on the area is the touch by the finger of the user.

2. The electronic device of claim 1, wherein the at least one processor is configured to:
identify whether a value, obtained based on the obtained probabilities and weights respectively set for the plurality of methods, is equal to or larger than a threshold,
based on identifying that the value is equal to or larger than the threshold, determine that the touch on the area is the touch by the finger, and
based on identifying that the value is less than the threshold, determine that the touch on the area is not the touch by the finger.

3. The electronic device of claim 1, wherein the at least one processor is configured to:
determine whether the touch on the area is the touch by the finger based on whether a number of probabilities that is equal to or larger than a threshold probability among the obtained probabilities is equal to or greater than a predetermined number.

4. The electronic device of claim 1, wherein the at least one processor is configured to:
based on determining that the touch on the area is the touch by the finger, perform, based on the touch on the area, a function of the electronic device, and
based on determining that the touch on the area is not the touch by the finger, disregard the touch on the area.

5. The electronic device of claim 1, wherein the at least one processor is configured to:
using a result of whether the touch on the area is the touch by the user's finger as a ground truth, update weights related to at least a portion of the plurality of methods.

6. The electronic device of claim 1, wherein the at least one processor is configured to:
based on the obtained image, obtain a position change of an area of the touch on the area,
based on the position change being equal to or larger than a threshold change, determine a probability that the touch on the area corresponds to the touch by the finger as a higher value, and
based on the position change being less than the threshold change, determine the probability that the touch on the area corresponds to the touch by the finger as a lower value.

7. The electronic device of claim 1, wherein the at least one processor is configured to:
by obtaining a maximum pixel value and a position of a row corresponding to the maximum pixel value for each of columns of pixels of the obtained image, obtain a plurality of maximum pixel values and positions of rows corresponding to the plurality of maximum pixel values, and
based on the plurality of maximum pixel values and the positions of the rows corresponding to the plurality of maximum pixel values, obtain a probability that the touch on the area corresponds to the touch by the finger.

8. The electronic device of claim 1, wherein the at least one processor is configured to:
obtain a moving speed of a trajectory of the touch on the area and a number of direction changes of the touch on the area, and
based on the moving speed and the number of direction changes, obtain a probability that the touch on the area corresponds to the touch by the finger.

9. The electronic device of claim 1, wherein the at least one processor is configured to:
based on a distance between an object included in the screen and an area of the touch on the area, obtain a probability that the touch on the area corresponds to the touch by the finger.

10. The electronic device of claim 1, wherein the at least one processor is configured to:
based on a touch shape, touch intensity, touch speed, and touch trajectory of the user's touches previously detected for the area, obtain a probability that the touch on the area corresponds to the touch by the finger.

11. A method for providing interaction with a screen projected from an electronic device, the method comprising:
while the screen is projected by a projector of the electronic device, obtaining, through a camera of the electronic device, an image of an area formed by light emitted by a light emitter of the electronic device;
based on the obtained image, obtaining, using a plurality of methods, probabilities that a touch on the area corresponds to a touch by a finger of a user, wherein the probabilities are obtained based on performing the plurality of methods, respectively; and
based on the obtained probabilities, determining whether the touch on the area is the touch by the finger of the user.

12. The method of claim 11, wherein the determining whether the touch on the area is the touch by the finger of the user comprises:
identifying whether a value, obtained based on the obtained probabilities and weights respectively set for the plurality of methods, is equal to or larger than a threshold;
based on identifying that the value is equal to or larger than the threshold, determining that the touch on the area is the touch by the finger; and
based on identifying that the value is less than the threshold, determining that the touch on the area is not the touch by the finger.

13. The method of claim 11, wherein the determining whether the touch on the area is the touch by the finger of the user comprises:
determining whether the touch on the area is the touch by the finger based on whether a number of probabilities that is equal to or larger than a threshold probability among the obtained probabilities is equal to or greater than a predetermined number.

14. The method of claim 11, further comprising:
based on the touch on the area based on determining that the touch on the area is the touch by the finger, performing a function of the electronic device; and
based on determining that the touch on the area is not the touch by the finger, disregarding the touch on the area.

15. The method of claim 11, further comprising:
using a result of whether the touch on the area is the touch by the user's finger as ground truth, updating weights related to at least a portion of the plurality of methods.

16. The method of claim 11, wherein the obtaining the probabilities comprises:
based on the obtained image, obtaining a position change of an area of the touch on the area;
based on the position change being equal to or larger than a threshold change, determining a probability that the touch on the area corresponds to the touch by the finger as a higher value; and
based on the position change being less than the threshold change, determining the probability that the touch on the area corresponds to the touch by the finger as a lower value.

17. The method of claim 11, wherein the obtaining the probabilities comprises:
by obtaining a maximum pixel value and a position of a row corresponding to the maximum pixel value for each of columns of pixels of the obtained image, obtaining a plurality of maximum pixel values and positions of rows corresponding to the plurality of maximum pixel values; and
based on the plurality of maximum pixel values and the positions of the rows corresponding to the plurality of maximum pixel values, obtaining a probability that the touch on the area corresponds to the touch by the finger.

18. The method of claim 11, wherein the obtaining the probabilities comprises:
obtaining a moving speed of a trajectory of the touch on the area and a number of direction changes of the touch on the area; and
based on the moving speed and the number of direction changes, obtaining a probability that the touch on the area corresponds to the touch by the finger.

19. The method of claim 11, wherein the obtaining the probabilities comprises:
based on a distance between an object included in the screen and an area of the touch on the area, obtaining a probability that the touch on the area corresponds to the touch by the finger.

20. The method of claim 11, wherein the obtaining the probabilities comprises:
based on a touch shape, touch intensity, touch speed, and touch trajectory of the user's touches previously detected for the area, obtaining a probability that the touch on the area corresponds to the touch by the finger.
